(19) United States
(12) Patent Application Publication
(10) Pub. No.: US 2005/0157308 A1
(43) Pub. Date: Jul. 21, 2005

(54) Apparatus and method for measuring thickness variation of wax film

(76) Inventors: Andrei Brunfeld, Cupertino, CA (US); Ilan Laver, Kfar Saba (IL)

Correspondence Address: GLENN PATENT GROUP, 3475 EDISON WAY, SUITE L, MENLO PARK, CA, 94025, US

(21) Appl. No.: 10/861,249

(22) Filed: Jun. 4, 2004

Related U.S. Application Data
(60) Provisional application No. 60/537,220, filed on Jan. 15, 2004.

(51) Int. Cl. G01B 11/02

(52) U.S. Cl. 356/504

(57) ABSTRACT

An apparatus and a method for measuring the thickness of wax film layer, bonded to a semiconductor wafer, are disclosed. Furthermore, the invention disclosed allows the detection of particles, such as dust particles embedded in the surface of the wax film. The invention uses optical measurements based on coherent illumination, interference of the rays reflected by the two surfaces of the wax, and imaging means that produces an image where defected can easily be distinguished from and non-defected areas. The invention leads to higher yields and therefore lower costs generally during the fabrication of semiconductor components, and particularly during the polishing stage of the wafer.

### CROSS REFERENCE TO RELATED APPLICATIONS

This application claims priority to U.S. provisional patent application Ser. No. 60/537,220 submitted Jan. 15, 2004, which application is incorporated herein in its entirety by this reference thereto.

### BACKGROUND OF THE INVENTION

1. Technical Field

The invention relates generally to semiconductor wafer polishers. More practically, the invention relates to an apparatus and method for accurately measuring the thickness of a wax layer used to bond a semiconductor wafer prior to a polishing process.

2. Description of the Prior Art

A critical step in a conventional semiconductor wafer process is the polishing step, which produces a high quality and damage-free surface on one face of a semiconductor wafer. Polishing of the semiconductor wafer is accomplished by a mechano-chemical process in which a rotating polishing pad rubs polishing slurry against the wafer. In a conventional semiconductor wafer polisher, the wafer is bonded with wax layer to a polishing block and then held against the rotating polishing pad by a polishing arm.

Semiconductor wafers must be polished particularly flat in preparation for printing circuits on the wafers by an electron beam-lithographic or photolithographic process. Flatness of the wafer surface on which circuits are to be printed is critical to maintain resolution of the lines, which may be as thin as 0.1 micrometer (micron).

Reference is now made to FIG. 1 which shows a semiconductor wafer 110 mounted on a polishing block 120. The wafer's back-side faces a polishing block 120, while the wafer's front-side is upwardly exposed. The semiconductor wafer 110 is typically attached to the polishing block 120 using a wax layer 130. To mount the semiconductor wafer 110 to the polishing block 120, first a wax coating is applied to the upper surface of a spinning polishing block 120. Next, the semiconductor wafer 110 is placed on the polishing block 120, thereby bringing the semiconductor wafer 110 into contact with the wax layer 130.

Application of the wax coating is not a perfectly controlled process and typically brings forth thickness variations, waviness, bubbles, embedded airborne particles, and so on. Due to the intrinsic elasticity of the semiconductor wafer 110, defects existent on the wax layer 130 generally tend to be transferred onto the semiconductor wafer 110 through the polishing process. Therefore, it is essential to have a wax layer perfectly uniform and without any defects.

A defect-free, precise and flat wax layer 130 is of utmost importance to the polishing process. Hence, the objective is to control the process of applying the wax layer 130 to the polishing block 120. The control process has to ensure a wax layer without any variations, i.e. without any thickness or shape variations, air bubbles, embedded particulates, or any other defects that may influence the polishing process, or even damage or cleave the wafer during polishing.

To achieve a uniform surface of the wax layer, there is a need to measure the thickness variations of the layer, i.e. film. However, in the related art, systems and methods for wax inspection and testing are not found. The reasons for lack of such systems relate to the difficulties in measuring the thickness of a wax film. These difficulties involve absorption in the film, film reflectivity, the film thickness, the film surface, the polishing block movement, and the block polishing geometry.

Therefore, it would be advantageous to provide a system that would efficiently measure and analyze the thickness variations of a thin film with a high thickness sensitivity and good surface spatial resolution. It would be further advantageous if the provided system would detect and discriminate particles residing or embedded on the film's surface.

### SUMMARY OF THE INVENTION

The invention provides an apparatus and method for measuring the thickness of the wax film deposited on a polishing block by spin-coating process. Furthermore, the invention disclosed allows the detection of embedded particles, such as dust particles residing on the surface of the wax layer. The presently preferred embodiment of the invention provides an optical system based on monochromatic (coherent) illumination source and an imaging system for performing the detection of the image of the wax film, e.g. wax layer 130. In the generated image both defected and non-defected areas can easily be distinguished. The invention allows higher yields and therefore lower costs during the fabrication of semiconductor components.

### BRIEF DESCRIPTION OF THE DRAWINGS

FIG. 1 is a side view of a semiconductor wafer mounted on a polishing block as known in the art;

FIG. 2 is a schematic representation of an apparatus for measuring the thickness variation a wax film in accordance with an embodiment of this invention;

FIG. 3 is a picture of an enlarged wax defect detected with the apparatus provided by the invention;

FIG. 4 is a schematic diagram describing the operation of an apparatus in accordance the invention;

FIG. 5 is an image of a wax film that includes four different fringe patterns;

FIGS. 6a and 6b provide an exemplary fringe pattern representing a normal surface of a film;

FIGS. 7a and 7b provide an exemplary fringe pattern representing shape defects;

FIGS. 8a and 8b provide an exemplary fringe pattern representing large defects;

FIGS. 9a and 9b provide an exemplary fringe pattern representing surface variations;

FIGS. 10a and 10b provide an exemplary fringe pattern representing small defects; and

FIG. 11 is a flowchart describing a method for measuring the thickness variations in accordance with an embodiment of the invention.

### DETAILED DESCRIPTION OF THE INVENTION

The invention provides an apparatus and method for measuring the thickness of the wax film deposited on a polishing block by spin-coating process. Furthermore, the invention disclosed allows the detection of embedded particles, such as dust particles residing on the surface of the wax layer. The presently preferred embodiment of the invention provides an optical system based on monochromatic (coherent) illumination source and an imaging system for performing the detection of the image of the wax film, e.g. wax layer 130. In the generated image both defected and non-defected areas can easily be distinguished. The invention allows higher yields and therefore lower costs during the fabrication of semiconductor components.

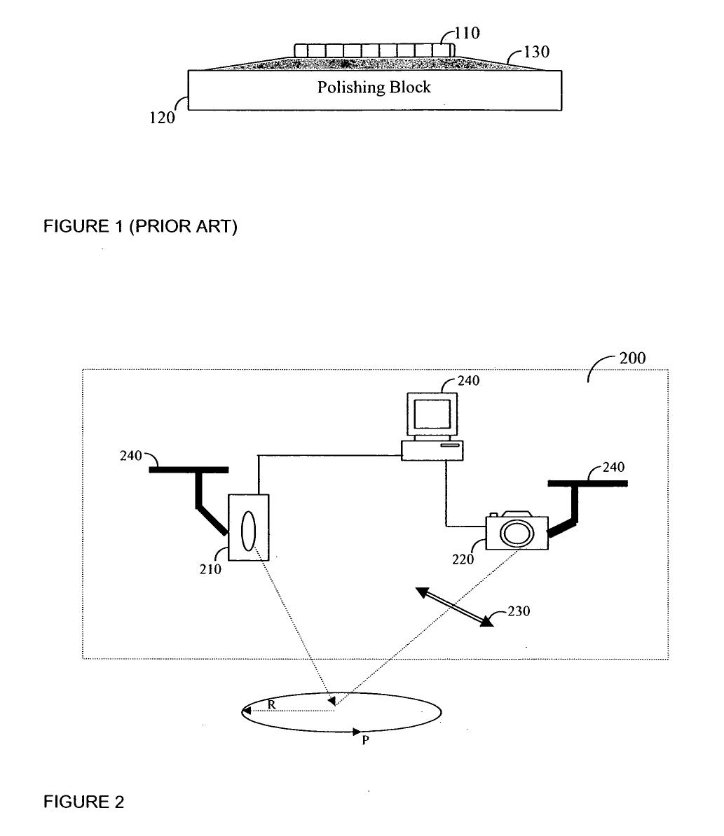

Reference is now made to FIG. 2, where a schematic representation of an apparatus 200 used for measuring the thickness variation of a wax film and for detecting particles on the film's surface, in accordance with a presently preferred embodiment of the invention, is shown. The apparatus 200 comprises an illumination source 210, a camera 220, an optical lens system 230, mechanical systems 240, and computing means 250. The illumination source 210 illuminates a wax film 130 that is bonded to a polishing block 120. The polishing block 120 is preferably externally flat because it acts as the reference surface for the entire polishing process. To achieve better consistency in the detection of the rays reflected from the wax film 130 surface and to improve the spatial resolution, the camera 220 covers only a relatively small field of view, i.e. a relatively small portion of the surface. Therefore, the camera 220 scans, or is scanned, over the surface of the wax film 130, for example, using mechanical systems 240 to cover the entire surface of wax film 130. The images acquired by camera 220 are independent images, which are subsequently stitched to form a continuous high resolution image of the wax film 130 layer.

The camera 220 may scan the wax film 130 using multiple techniques, such as a step-and-repeat and a line-by-line technique. The technique to be used is determined by the type of camera 220. Specifically, a two-dimensional camera acquires the images using the step-and-repeat technique, while one-dimensional camera, e.g. a line camera, acquires the images line-by-line and produces a two dimensional image therefrom. The step-and-repeat technique acquires images in uniform rows and columns and prepares a two-dimensional image therefrom.

In one embodiment of the invention, an in-line imaging process is used to scan the wax film 130. The in-line imaging process is used when measuring the thickness variation of a wax film, e.g. the wax film 130, bonded to a semiconductor wafer, e.g. the semiconductor wafer 110. This process achieves excellent results due to the radial symmetry of the semiconductor wafer to be measured and the continuous rotation movement of the polishing block, e.g. the polishing block 120. The in-line imaging process uses a linear camera, e.g. the camera 220, synchronized with the rotation of the wafer, where at each step a single ring image of the wax layer is exposed at the specific radial position. Stepping the camera 220 at various radii and stitching the ring images allows coverage of the entirety of the wax film's surface and full inspection of the wax layer.

The mechanical systems 240 move the illumination source 210 and the camera 220, in predetermined steps, along the radius axis “R” of the polishing block 120. This is performed to ensure coverage of the entirety of the wax film's 130 surface. The illumination source 210 may be, but is not limited to, a laser, e.g. a diode laser, or any monochromatic source, such as a discharge lamp fitted with the appropriate color filter. The specific wavelength, i.e. color, of illumination source 210 depends on the specific application and the possibility of dye existing in the wax film 130. The optical lens system 230 is a standard system for imaging objects and may be any lens or lens system that produces an image of the wax film 130 for the camera 220. One of the preferred characteristics of the optical lens system 230 is a large numerical aperture that is used to avoid possible collection variations between the center and the edges of the detection field of view.

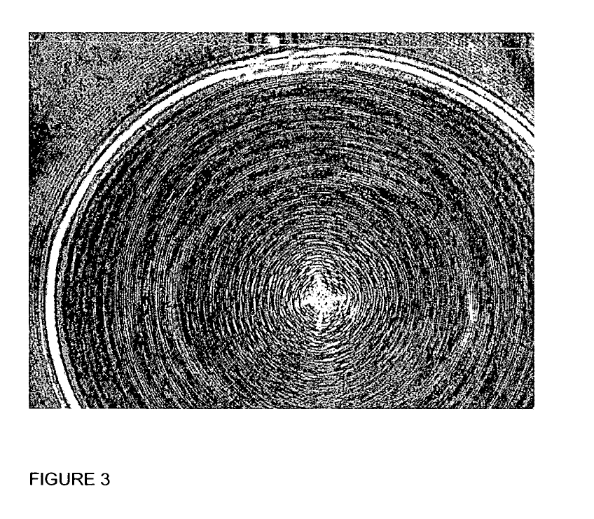

The camera 220 detects the images formed by the beams reflected from the polishing block 120 and the wax film 130. The two beams interfere and create an interference image of the wax film 130. The image is modulated according to the thickness of the wax film 130 layer. The camera 220 may be a color camera, i.e. with color coding detector, or monochrome camera with synchronized color light sources. FIG. 3 shows a picture of a wax film taken by the camera 220.

The computing means 250 is capable of executing a plurality of tasks required to control and manage the apparatus 200. These tasks include, but are not limited to, controlling the movement of the camera 220 and the illumination source 210, image processing, data acquisition, storage and processing, generating reports, and displaying the reports.

In one embodiment, the apparatus 200 may include a collimator (not shown) connected to the illumination source 210 to improve the quality of the light coupled into the wax film 130 and to reduce the angular spread of the incoming rays. In this embodiment, the illumination angle and the distance of the illumination source 210 from the polishing block 120 can easily be controlled.

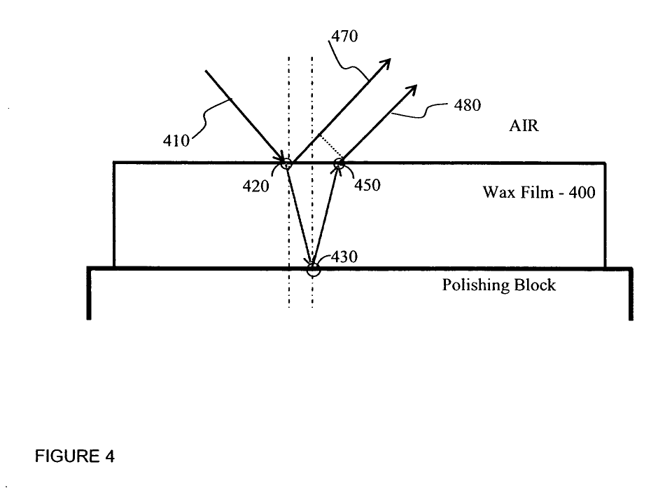

Reference is now made to FIG. 4, where an exemplary diagram describing the operation of the apparatus 200 is shown. FIG. 4 illustrates propagation of an exemplary light beam from air through a film 400 having a thickness ‘d’ and a refractive index ‘n’. An illumination beam 410, produced by the illumination source 210, is split at a splitting point 420 into two different beams 470 and 490. The beam 490 hits the upper surface of the polishing block 120 (the lower surface of the film) at a reflection point 430. The beam 480 is the beam which is reflected from the polishing block 120 and which travels back through the film 400 in the air. The beams 470 and 480 are the interfering beams and are transmitted to the camera 220 through the lens system 230. The optical path difference between the points 420 and 450 is derived from the intensity of the interfering beams 470 and 480. The intensity of an interfered beam is determined by the geometrical path, the reflective index ‘n’, and the reflectivity of the wax film 130 and the polishing block 120 surfaces. The intensity of the interfered beam varies in a sinusoidal manner with the thickness of the wax. Due to the relatively small lateral shift between the interfering beams 470 and 480, these beams may be considered as if they were reflected from the same point on the wax film 130 surface. Therefore, the wax thickness can be presented in terms of beam intensity. The camera 220 forms the wax film image from the interfering beams 470 and 480, i.e. the thickness of the wax film and its surface variations are derived from the intensity of the interfering beams 470 and 480. The variation with one wavelength of the optical path generates a complete period of the intensity, and the complete topography of the film variations can be represented in one image. The technique described herein with reference to FIG. 4 is an imaging interferometry technique. The inventors have noted that by using an imaging interferometer with temporal coherent light a good interference fringe contrast is achieved. The high contrast fringe allows ready identification of both high and low frequency thickness variations, i.e. fringes. The thickness value of a fringe is calculated relative to the optical path variation. The changes of the optical path in a given area are seen as a number of fringes per unit surface, i.e. as a fringe frequency.

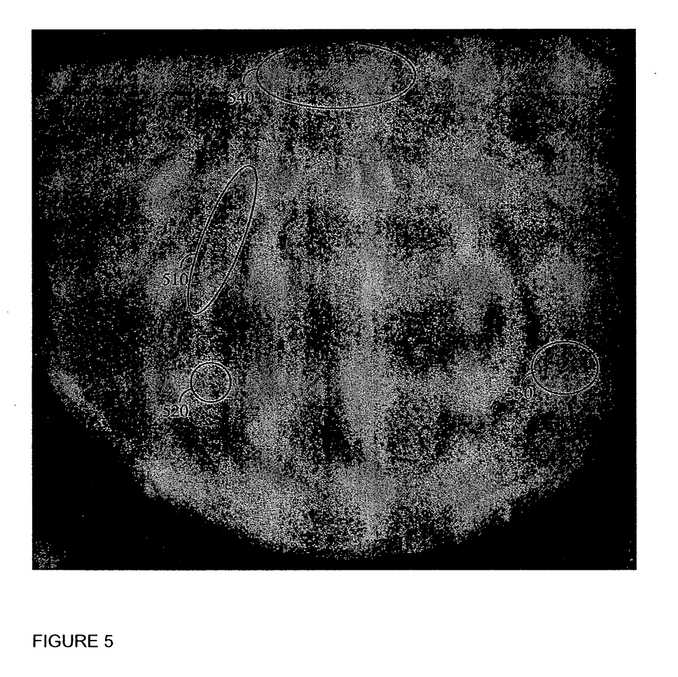

Referring now to FIG. 5, an exemplary image 500 of a wax film generated by the apparatus 200 is shown. The image 500 includes four different fringe patterns marked as 510, 520, 530, and 540. The fringe pattern 510 represents low frequency fringes. The fringe pattern 520 represents circular fringes or close contour, which may result from an air bubble on the film. The fringe pattern 530 represents irregular close contour fringes that result from non-adhesion of the film on the polishing block. The fringe pattern 540 represents high frequency fringe resulting from the film waviness. The fringe patterns 520, 530, and 540 indicate defects of the film.

Through an image processing procedure, the apparatus 200 may discriminate and classify multiple types of defects of the film 400. The image processing procedure evaluates and counts fringes and then translates the fringes to height variations. The height variation is determined by the height difference between two successive fringes. According to the characteristics of the interference image of the film, defects can be classified in several categories, according to the user definition. For example, defects may be classified as general shape defects, large defects, surface variations, and small defects (bubbles).

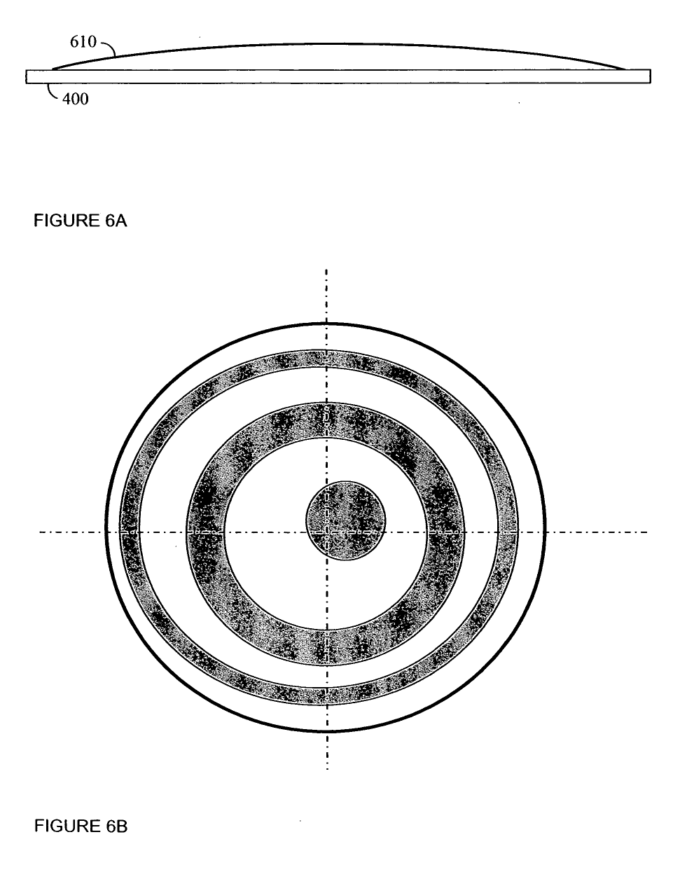

FIGS. 6, 7, 8, 9, and 10, show defects identified using the invention for various defect categories. It should be noted that these categories are provided for exemplary purposes only. Specifically, the disclosed invention is operative in any defects classifications defined by the user.

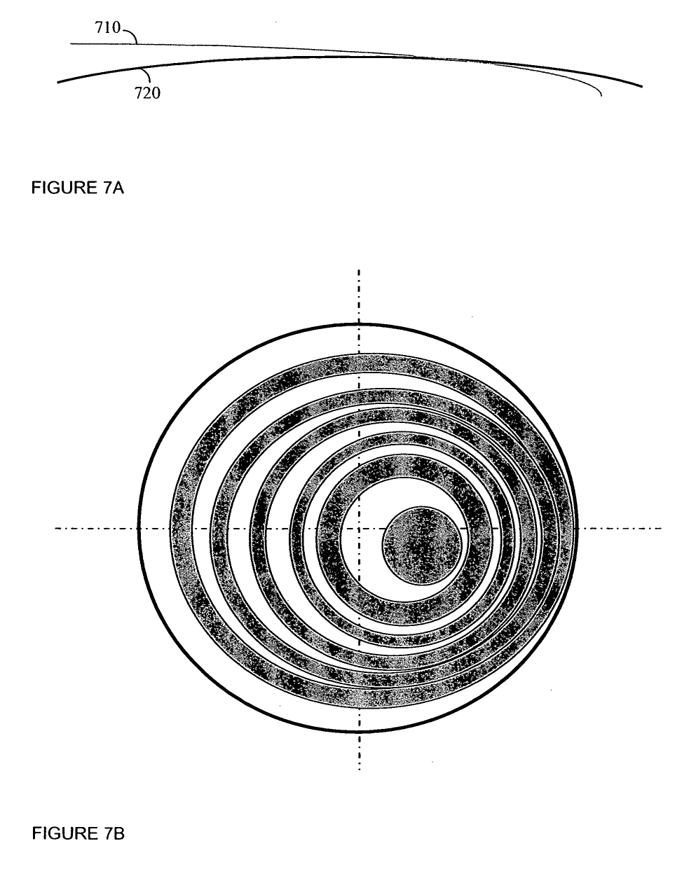

A defect is defined as an anomaly from a constant thickness of a wax film. The ideal thickness of a wax film is in general a constant one, but depending on the limitations of the wax deposition technique, some surfaces can have other shapes. For example, current spin coating techniques generate a shallow convex surface. The challenge is to have the convex shape as close to a flat one as possible. An illustration of a good thickness of a wax film is shown in FIG. 6A, where the wax thickness is minimal. The resulting fringe pattern is characterized by low fringe frequency, usually only three fringes over the entire film surface. FIG. 6B shows an exemplary fringe pattern that represents the normal film's interference image. Shape defects are anomalies of the entire film's surface. As can be seen in FIG. 7A the shape of the upper surface, i.e. line 710, is shifted relative to the normal surface, i.e. line 720. FIG. 7B shows an exemplary fringe pattern that represents the shape defects. As can be seen in FIG. 7B the fringe pattern is characterized by symmetrical larger variations.

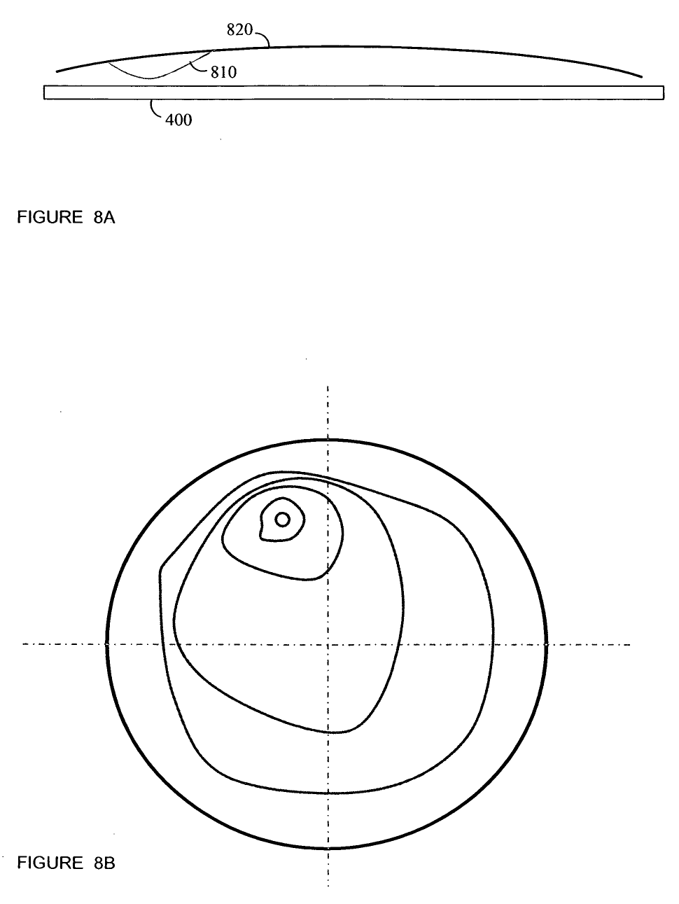

Large defects are local anomalies of the film's surface relative to the normal surface. As can be seen in FIG. 8A, the large defects, i.e. line 810, are limited to a specific area, encompassing most of the surface of the film, i.e. line 820. FIG. 8B shows an exemplary fringe pattern that represents the large defects. As can be seen in FIG. 8B, the fringe pattern is characterized by local close contours and large variations, i.e. high fringe frequency.

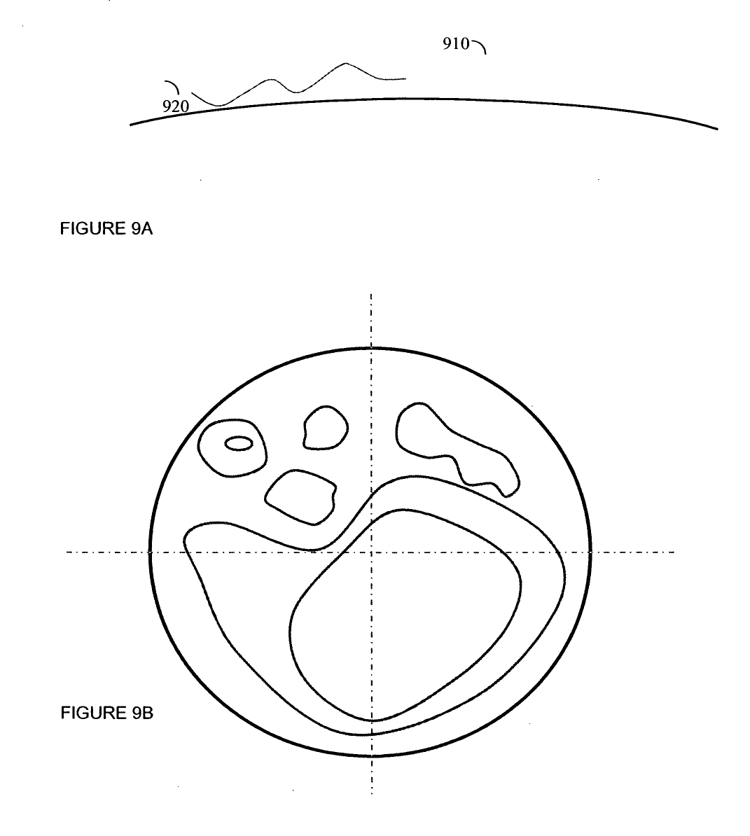

Surface variations are anomalies without a specific trend. As can be seen in FIG. 9A, the surface variations, i.e. line 910, are presented as waves on the film's surface, i.e. line 920. Surface variations may be localized to a specific region or spread all over the surface. Unlike the other defects, the surface variations do not tend to appear as close-contour fringes. As can be seen in FIG. 9B, the fringe pattern of the surface variations is characterized by local inconsistent variations, without any specific shape.

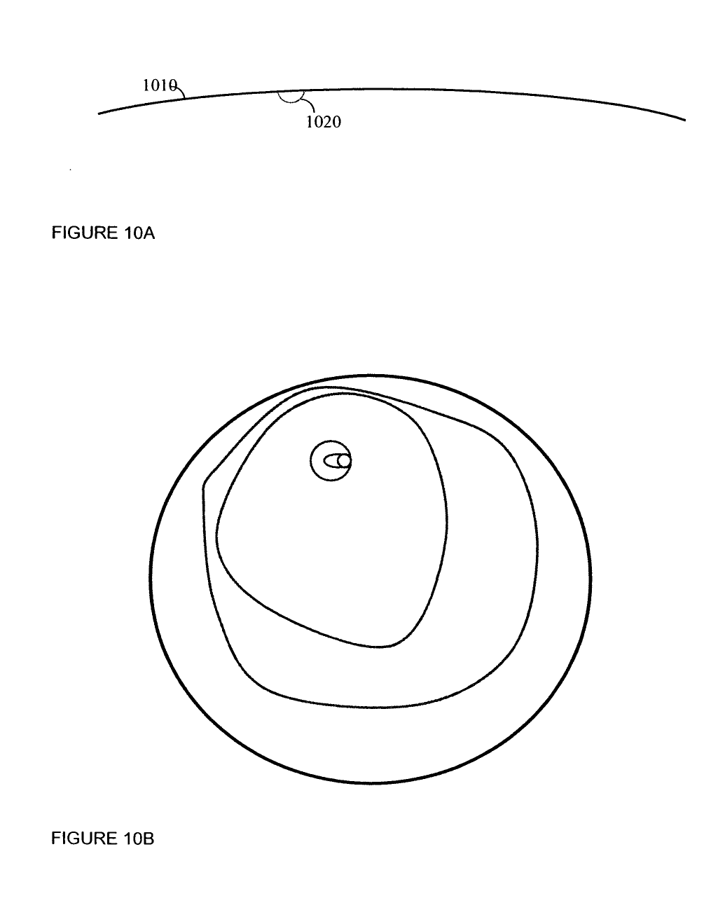

Small defects, e.g. bubbles, are local anomalies of relatively small size and large height variations. As can be seen in FIG. 1A, the small defect, i.e. line 1010, is presented as a pit on the film's surface, i.e. line 1020. As can be seen in FIG. 10B at the fringe pattern, the small defects shape is represented by a very high fringe frequency, creating a sharp boundary at the edge of the defect. Within the defect area the fringes are all with a close contour, and the number of fringes is related to the smoothness of the defect.

The apparatus 200 is further capable of detecting particles residing on the film surface. Particles deposited on the wax film often change the shape of the film surface. Namely, the particles generate pits or bubbles on the film's surface. Therefore, a fringe pattern of the particles is similar to a fringe pattern of the small defects, e.g. the fringe pattern shown in FIG. 10B.

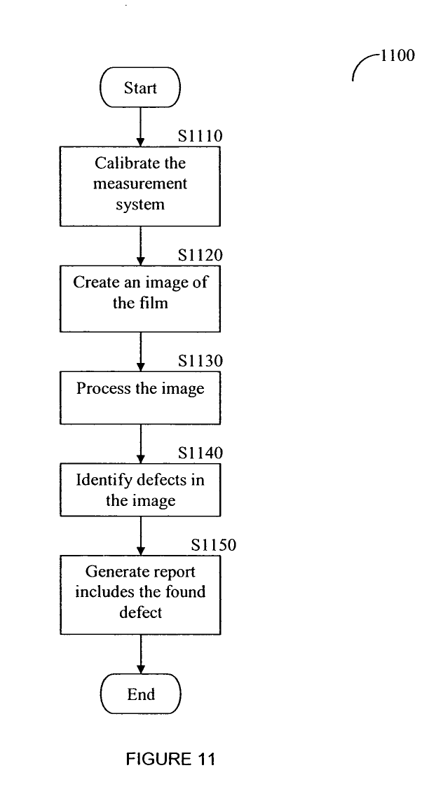

Reference is now made to FIG. 11, where a flowchart 1100 describing the method for measuring the thickness variations of a thin film and for detecting particles embedded on the thin film, in accordance with an embodiment of the invention, is shown.

At step S1110, the apparatus 200 is calibrated to achieve the maximum fringe contrast. The apparatus 200 is also set for the correct magnification of the imaging system, i.e. the illumination source 210, the camera 220, and the optical lens system 230. The calibration process also provides the necessary information for radial steps to allow a correct stitching. The calibration process comprises setting the illumination angle and power of the illumination source 210 and measuring the actual object-to-image magnification. The values of the illumination angle and illumination power are determined according to the reflective index “n” of the film and the wavelength of the illumination source. In addition, a system calibration factor is set to a predefined value. The calibration factor determines height change necessary to have an intensity variation of one fringe. The value of the calibration factor depends on geometry and the refractive index of the film.

At step S1120, the film is illuminated exposing for each step a specific field of view, and by that acquiring each step a single image. Once the singular images of the entire surface were acquired, these images are stitched to form the complete surface image. It should be noted that the process of step by step acquisition is performed for the purposes of achieving a higher image resolution.

At step S1130, the surface image generated by the camera 220 is processed to achieve clean and high resolution picture of the film. This includes:
1) applying a low-pass filter to remove noise, reduce data, and create a general image;
2) creating fringes with minimal background; and
3) creating a fringe map by calculating maxima, minima, and the average position of the fringe pattern.

At step S1140, the defects revealed in the fringe map are identified and classified. To detect the defects, first the fringe frequency and the local anomalies are defined.

At step S1150, a report that includes the defects' types and the position of the defects on the film is generated and displayed to the user.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. An apparatus for measuring thickness variations in a film having an upper surface and a lower surface, comprising:
means for illuminating said film;
means for collecting light reflected from said upper film surface and light reflected from said lower film surface;
means for producing an interference image from said light reflected from said upper film surface and said lower film surface; and,
means for interfacing a processor with said illumination means and said light collecting means; and
wherein said processor performs image processing on said interference image captured by said light collecting means to determine thickness variations in said film.

2. The apparatus of claim 1, wherein said apparatus further comprises:
mechanical means for physically moving said light collecting means and said illumination means relative to said film surface.

3. The apparatus of claim 1, wherein said illumination means comprises any of:
a laser, a monochromatic source, and a muliti-wavelength source

4. The apparatus of claim 3, wherein said illumination means produces light having several different wavelengths.

5. The apparatus of claim 1, wherein said light collecting means comprises:
a detector; and
an optical lens system.

6. The apparatus of claim 1, wherein said detector comprises any of:
a CMOS camera, a CCD camera, a one-dimensional camera, a two-dimensional camera, and a linear camera.

7. The apparatus of claim 6, wherein said one-dimensional camera uses a line-by-line process to acquire said interference image.

8. The apparatus of claim 6, wherein said two-dimensional camera uses a step-and-repeat process to acquire said interference image.

9. The apparatus of claim 6, wherein said linear camera uses an in-line process to acquire said interference image.

10. The apparatus of claim 1, wherein said interference image is produced by exposing a portion of said film surface.

11. The apparatus of claim 10, further comprising:
means for stitching a plurality of independent interference images to form a continuous high resolution image of said film surface.

12. The apparatus of claim 1, said processor further comprising:
means for detecting particles embedded in said film.

13. The apparatus of claim 1, wherein said film comprises:
a wax film that is bonded to a semiconductor wafer.

14. The apparatus of claim 1, further comprising:
means for processing said interference image to achieve clean and high resolution
image of the film with at least one of the following:
a low-pass filter for removing noise, reducing data, and creating a general image;
means for creating fringes with minimal background; and
means for creating a fringe map by calculating maxima, minima, and an average position of a fringe pattern.

15. A method for measuring thickness variations in a film, comprising the steps of:
illuminating said film with a light source that produces light having a specific wavelength;
collecting light beams reflected from both of an upper surface and a lower surface of said film with a light collection means;
acquiring a singular image using light collection means;
moving said light source and said light collection means over said upper surface of said film to capture a plurality of singular images, wherein an entire surface of said film is imaged; and
stitching said singular images to form a complete high resolution image of said film surface.

16. The method of claim 15, further comprising the step of:
processing the surface image of said film to detect defects on said surface.

17. The method of claim 15, wherein said illumination means comprises any of:
a laser, a monochromatic source, and a multi-wavelength source.

18. The method of claim 15, wherein said light collecting means comprises:
a detector; and
an optical lens system.

19. The method of claim 18, wherein said a detector comprises any of:
a CMOS camera, a CCD camera, a one-dimensional camera, a two-dimensional camera, and a linear camera.

20. The method of claim 15, wherein said singular image is acquired using a step-and-repeat process.

21. The method of claim 15, wherein said singular image is acquired using a line-by-line process.

22. The method of claim 15, wherein said singular image is acquired using an in-line process.

23. The method of claim 15, wherein said singular image comprises a portion of said film surface.

24. The method of claim 15, said moving step comprising the step of:
using a mechanical means to effect motion.

25. The method of claim 15, wherein said film comprises a wax film that is bonded to a semiconductor wafer.

26. The method of claim 15, further comprising the step of:
detecting particles embedded in said film.

27. The method of claim 15, further comprising the step of:
processing said acquired image to achieve clean and high resolution image of the film by performing at least one of the following steps:
applying a low-pass filter to remove noise, reduce data, and create a general image;
creating fringes with minimal background; and
creating a fringe map by calculating maxima, minima, and an average position of a fringe pattern.
